(19) United States
(12) Patent Application Publication
(10) Pub. No.: US 2007/0231554 A1
(43) Pub. Date: Oct. 4, 2007

(54) Extruded Sheet, Products Manufactured Therefrom and Their Preparation Process

(75) Inventors: Catia Bastioli, Novara (IT); Angelo Bastioli, Foligno (IT); Roberto Lombi, Novara (IT)

Correspondence Address: CONNOLLY BOVE LODGE & HUTZ LLP, 1875 EYE STREET, N.W., SUITE 1100, WASHINGTON, DC, 20036, US

(73) Assignee: Novamont S.p.A., Novara (IT)

(21) Appl. No.: 11/596,461

(22) PCT Filed: May 9, 2005
(86) PCT No.: PCT/EP05/04984

§ 371 Date: Nov. 13, 2006

(30) Foreign Application Priority Data
May 11, 2004 (IT) MI2004A000947

(51) Int. Cl. C08J 5/18; A01K 15/02; C08J 9/12

(52) U.S. Cl. 428/219; 264/339

(57) ABSTRACT

Extruded sheet with a density greater than 300 kg/m³, or preferably greater than 400 kg/m³, made of biodegradable materials of synthetic and/or natural origin, suitable for use in the production of chew toys for domestic pets. The sheet is essentially composed of: 5-98%, and preferably 15-95% or, more preferably, 20-90% by weight of at least one polysaccharide; 1-60%, and preferably 2-50% or, more preferably, 5-45%, by weight of at least one biodegradable thermoplastic polymer; 1-35%, preferably 3-35, more preferably 5-35 by weight of a plasticizing agent.

The present invention refers to an extruded sheet particularly suitable for use in the sector of chew toys for domestic pets.

The extruded sheet according to the present invention can be in the form of compact or partially expanded extruded sheet. When said sheet is produced in partially expanded form, it is particularly suitable for manufacturing chew toys with a surface texture reminiscent of leather, and consequently particularly appealing to domestic pets.

In the world of chew toys for domestic pets, one of the most widespread types of product is made of buffalo (or other bovine) skin, shaped to resemble an animal bone, which is particularly appealing to domestic pets. These products are manufactured mainly using two methods, either by injection molding “solutions” of animal skin, or by processing the hide as is, which is cut into pieces of a suitable size, then rolled up and knotted at the ends.

To prepare the latter type of product, the buffalo hide must undergo a suitable disinfection process, which usually involves, for instance, a period of quarantine, followed by washing in alkaline and acid solutions, and a final drying process.

These days, partly because of concerns raised on a vast scale by animals spreading certain germs that are pathogenic to humans, the market (including the sector dealing in articles for household pets) is seeking alternative solutions to the use of animal products using different products, particularly of vegetable origin.

The extruded sheet according to the present invention can meet this need, enabling the production of chew toys for domestic pets with mechanical, appetizing and even tactile characteristics that make them particularly appealing to household pets as a substitute for the traditional articles made of animal skin.

The extruded sheet according to the present invention is characterized by a density greater than 300 kg/m³ and can be manufactured from synthetic and/or natural biodegradable materials.

When the density is less than about 1000 kg/m³, preferably less than 800 kg/m³, the extruded sheet according to the present invention can be in the form of a partially expanded sheet i.e. presenting a diffusion of cells, preferably a diffusion of homogeneous cells.

The present description refers, in particular, to an extruded sheet made using vegetable materials, but it can also be manufactured using materials of entirely synthetic origin.

If it is made mainly of vegetable materials, the extruded sheet according to the present invention is characterized by a density greater than 300 kg/m³, and preferably greater than 400 kg/m³, and it includes the following main components:
5-98%, preferably 15-95%, more preferably 20-90% by weight of at least one polysaccharide;
1-60%, preferably 2-50%, more preferably 5-45%, by weight of at least one biodegradable thermoplastic polymer;
1-35%, preferably 3-35, more preferably 5-35 by weight of a plasticizing agent.

The polysaccharide used in the preparation of the partially expanded sheet may be native starch, and preferably from maize, potato, tapioca, rice, wheat or pea, or a starch with a high amylose content and the so-called waxy starches. Physically or chemically modified starches are also suitable, e.g. ethoxylated starches, oxypropylated starches, acetate starches, butyrate starches, propionate starches, cationic starches, oxidized starches, crosslinked starches, gelatinized starches, destructured starches and starches complexed from polymer structures. The term polysaccharide covers not only the refined starch, but also the grains containing both starch and cellulose, hemicellulose, cellulose products, alginates.

The biodegradable thermoplastic polymers suitable for use as components of said partially expanded sheet include:
a) natural and other polymers, particularly those deriving from cellulose, e.g. cellulose acetate, cellulose propionate, cellulose butyrate, alkylcellulose, hydroxyalkylcellulose, carboxyalkylcellulose and their copolymers, and also chitosan, pullulan, casein and caseinates, gluten, zein, soy proteins, alginic acid and alginates, natural rubbers;
b) synthetic or fermented biodegradable polymers, particularly polyesters such as homopolymers or copolymers of aliphatic hydroxyacids with 2 to 24 carbon atoms, or the corresponding lactones or lactides,
   poly(-ε-caprolactone), its graft or block copolymers, the reaction products of the oligomers or polymers of caprolactone with aromatic or aliphatic isocyanates, copolymers with lactic acid, with glycolic acid, with poly-hydroxybutyrates and poly-hydroxybutyrate/valerate;
   polymers of lactic acid or lactide, polymers of glycolic acid or polyglycolide, copolymers of lactic acid or glycolic acid;
   long-, medium- and short-chain poly-hydroxyalkanoates, such as poly-hydroxybutyrates (e.g. poly-hydroxybutyrate/valerate P, poly-hydroxyhexanoates, poly-hydroxyoctanoates, poly-hydroxydecanoates and copolymers with other polyesters;
c) polyesters deriving from bifunctional acids and aliphatic diols, such as:
   aliphatic or aliphatic-aromatic polyesters, e.g. polyalkylene adipates, polyalkylene succinates, polyalkylene azelates, polyalkylene sebacates, polyalkylene brassylates, possibly copolymerized with aliphatic or aromatic isocyanates, or possibly given extra weight by means of chain extenders, such as polyethylene adipate, polybutylene adipate, polyethylene adipate-co-terephthalate, polybutylene adipate-co-terephthalate, polyethylene succinate, polybutylene succinate, polybutylene succinate-co-adipate, polyethylene azelate, polybutylene azelate, polyethylene sebacate, polybutylene sebacate, polyethylene sebacate-co-terephthalate, polybutylene sebacate-co-terephthalate, polyethylene brassylate, polybutylene brassylate;
d) polymers capable of interacting with and complexing the starch, i.e. polymers containing hydrophilic groups alternating with hydrophobic sequences such as:
   ethylene-vinyl alcohol copolymers containing up to 50% by weight, and preferably 10-44% by weight, of ethylene units, ethylene-vinyl alcohol copolymers oxidized or terminated with fatty acids, or grafted with polycaprolactone, or modified with acrylic or methacrylic monomers and/or pyridine;
   ethylene-vinyl acetate copolymers, even partially hydrolyzed;
   ethylene-acrylic ester copolymers;
   ethylene-acrylic ester-maleic anhydride, or ethylene-vinyl acetate-glycidyl methacrylate terpolymers;
   copolymers of ethylene with unsaturated acids such as acrylic acid, methacrylic acid, crotonic acid, itaconic acid, maleic anhydride, etc., and particularly ethylene-acrylic acid copolymers containing 5-50% by mole fraction, and preferably 10-30%, of units deriving from acrylic acid;
   ethylene-vinyl acetate terpolymers entirely or partially hydrolyzed with acrylic or methacrylic or crotonic or itaconic acid;
   aliphatic polyamides 6-6, 6-9 or 12, aliphatic polyurethanes, random or block polyurethane-polyamide, polyurethane-polyether, polyurethane-polyester, polyamide-polyester, polyamide-polyether, polyester-polyether copolymers;
   polycaprolactone-urethane where the dimension of the polycaprolactone block comes between 300 and 3000 by molecular weight and where the isocyanates used are MDI (methylene-diphenyl diisocyanate) toluene diisocyanate, hexamethylene diisocyanate.
e) polymers that are soluble, or in any case capable of hydrogen binding with the starch, and particularly polyvinyl alcohol in the various degrees of hydrolysis, modified with acrylates and methacrylates if necessary, polyvinyl alcohol that has been pre-elasticized or modified to reduce its melting point, containing gelling agents, where necessary, e.g. boric acid, borates or phosphates, vinyl acetate copolymers in various degrees of hydrolysis with vinyl pyrrolidone or styrene, polyethyl oxazoline, polyvinyl pyridine.

The preferred thermoplastic polymers are polyvinyl alcohol, the copolymers of an olefin monomer, preferably ethylene, with a monomer selected from among the following: vinyl alcohol, vinyl acetate, acrylic acid and methacrylic acid, aliphatic polyesters, e.g. polycaprolactone, polybutylene succinate and their copolymers, aliphatic-aromatic polyesters, e.g. polybutylene adipate-co-terephthalate, polybutylene sebacate-co-terephthalate, aliphatic polyamides and urethane polyesters.

The plasticizing agents suitable for use as components of the partially expanded sheet are those described, for instance, in EP-A-0 575 349, the content of which is intended as being incorporated in the present invention. Glycerin, sorbitol, mannitol, erythritol and low-molecular-weight polyvinyl alcohol are particularly suitable, as are the products of oxyethylates and oxypropylates of the aforementioned compounds, citrates and acetins.

In case of partially expanded extruded sheet according to the invention, the expansion is performed by means of the water contained in the mixture, either relying on the water naturally present in the polysaccharide and any additional water, or using a suitable physical and/or chemical foaming agents or mixtures thereof. The use of CO₂ in gaseous form, possibly combined with water and/or other physical and chemical foaming agents, is preferable. Suitable chemical foaming agents, among others, are citric acid, bicarbonate and combinations thereof.

The foaming agent is preferably delivered to a part of the extruder where the original mixture is in a molten state. In particular, the foaming agent is delivered to an area near the front of the extruder to avoid any regurgitation of the molten mass towards the extruder inlet interfering with the extrusion process.

CO₂ is delivered in concentrations coming between 0.1 and 15% of the total mass to an area where the molten material is at a temperature of between 100 and 180° C., and preferably between 120 and 160° C.

Using CO₂ also facilitates the formation of homogeneous cells in the partially expanded material.

The base components for the mixture can be delivered to the extruder as is, or they can be delivered in the form of previously extruded or pelletized granules.

The base components can also contain suitable additives, e.g. lubricants and/or dispersants, colorings, fillers, flavorings, appetizers, medications, vitamins, micro- and nano-spheres with controlled-release active ingredients, nucleating agents, such as talc, etc.

The extruder may be fitted with flat or tubular heads, though tubular heads are definitely preferable.

After extrusion, the extruded sheet, either in the form of partially expanded or compact extruded sheet, can be processed immediately to manufacture the end products, and particularly chew toys for domestic pets, or it can be stocked in reels for subsequent manufacturing.

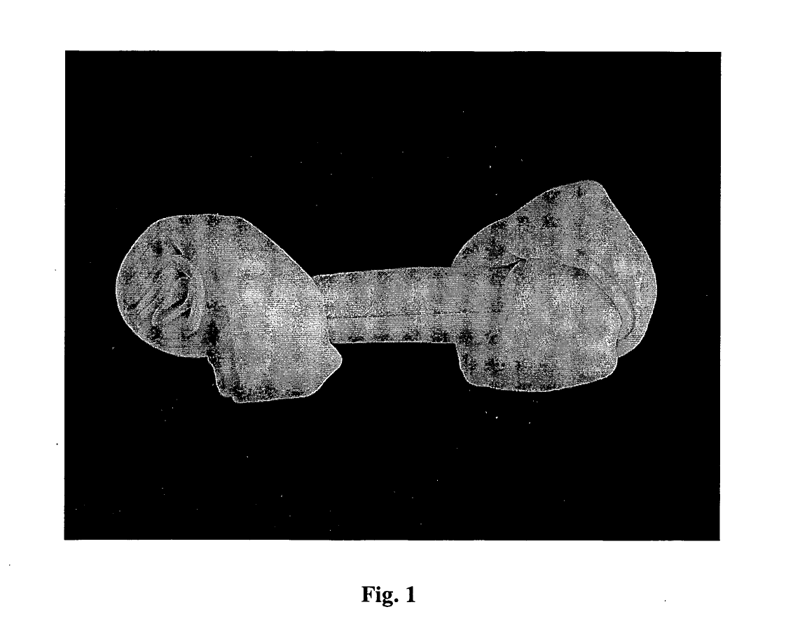

The extruded sheet according to the invention, either in partially expanded or in compact form, can be used to make end products, e.g. chew toys for domestic pets, using the normal technologies known to a person skilled in the art, e.g. by thermoforming. In a preferred embodiment of the process for preparing the end product, the extruded sheet is cut into pieces of suitable length, which are then rolled along their major axis and knotted at the two ends so as to form a product resembling the shape of an animal bone, as illustrated in FIG. 1.

In the case of the material being rolled and tied in a knot, to make the extruded sheet more readily workable, said sheet preferably undergoes a process of impregnation with water, water vapor, or any other plasticizing fluid that makes it sufficiently plastic for subsequent handling without affecting the chemical and physical characteristics of the material. This enables the sheet to be adapted to create a great variety of shapes.

The sheet can be converted into the end product using suitable mechanized means, or by hand.

In case of partially expanded extruded sheet, due to the roughness of the surface, the sheet exhibits a surface texture reminiscent of leather and consequently particularly appealing to domestic pets. In such a case the average surface roughness is higher than 3 μm, preferably higher than 5 μm.

### EXAMPLES

The invention is further illustrated by means of the following non-restrictive examples.

### Example 1

### Partially Expanded Extruded Sheet

A mixture comprising:

| | |
|---|---|
| maize starch | 45.5 |
| glycerin | 25.5 |
| EVOH | 15.5 |
| EVA | 13.4 |
| Talc | 0.1 |

is delivered at a flow rate of 78 kg/hour to a slow, co-rotating two-screw extruder with a screw diameter (d) of 113.8 mm and an L/D ratio of 19:1. CO₂ has been fed with a throughput of 9 kg/hour (corresponding to 11.5% of the flow rate).

The end of the extruder is fitted with an extrusion head for producing tubular sheets with a diameter of 100 mm and a lip opening of 0.5 mm.

The temperature profile set on the extruder is as follows: 155; 180; 200; 125; 140×2; 70; 110.

The thickness of the extruded sheet is approximately 2 mm and the density of the sheet is 520 kg/m³.

The extruded sheet is cut by a suitable shearing device so as to obtain a flat continuous sheet with a width of approximately 33 cm. Pieces are then cut from said sheet to a size of 16.5×65.0 cm.

Said pieces of sheet are then steeped in H₂O at 50° C. for 30 seconds so as to reach a water content in the sheet corresponding to approximately 19%, then the sheets are dried with warm air until the water content is approximately 12%. The sheet is then rolled along its longitudinal axis and a knot is tied in each end, thus obtaining a product in the shape of a bone the main aesthetic, mechanical and palatability features of which are as shown in FIG. 1.

The roughness of the bone has been tested with a surface roughness tester Mitutoyo Surftest-401. The roughness was ranging between 5-15.5 μm with an average of 9.9 μm.

### Example 2

### Compact Extruded Sheet

A mixture comprising:

| | |
|---|---|
| maize starch | 47.5 |
| sorbitol | 21.7 (in 30% water) |
| EVOH | 17.5 |
| glycerin | 7.9 |
| PBTA | 5.0 (Polybutylen adipate-co-terephtalate with MFI3 g/10 |
| | min and terephtalic percentage of 47%) |
| Erucamide | 0.4 |

is delivered at a flow rate of 73 kg/hour to the co-rotating two-screw extruder of example 1.

The temperature profile set on the extruder is as follows: 155; 180; 200; 125; 140×2; 70; 110.

The thickness of the extruded sheet is approximately 2 mm and the density of the sheet is 1400 kg/m³.

The produced extruded sheet is cut by a suitable shearing device so as to obtain a flat sheet approximately 33 cm. Pieces are then cut from said sheet to a size of 16.5×65.0 cm.

Said pieces of sheet are then steeped in H₂O at 50° C. for 60 seconds so as to reach a water content in the sheet corresponding to approximately 19%, then the sheets are dried with warm air until the water content is approximately 12%. The sheet is then rolled along its longitudinal axis and a knot is tied in each end, thus obtaining a product in the shape of a bone.

The roughness of the bone has been tested with a surface roughness tester Mitutoyo Surftest-401. The roughness was ranging between 0.75-0.95 μm with an average of 0.9 μm.

1. Chew toy obtained from an extruded sheet in a partially expanded form, having a density greater than 300 kg/m³, made of biodegradable materials of synthetic and/or natural origin, characterized by comprising the following components:
5-98% by weight of at least one polysaccharide;
1-60% by weight of at least one biodegradable thermoplastic polymer;
1-35% by weight of a plasticizing agent;
said partially expanded extruded sheet having an average surface roughness higher than 3 μm.

2. Chew toy according to claim 1, characterized by a density greater than 400 kg/m³

3. Chew toy according to claim 1 characterized in that said biodegradable materials are of vegetable origin.

4. Chew toy according to claim 1, characterized by comprising the following components:
15-95% by weight of at least one polysaccharide;
2-50% by weight of at least one biodegradable thermoplastic polymer;
3-35% by weight of a plasticizing agent.

5. Chew toy according to claim 4, characterized by comprising the following components:
20-90% by weight of at least one polysaccharide;
5-45% by weight of at least one biodegradable thermoplastic polymer;
5-35% by weight of a plasticizing agent.

6. Chew toy according to claim 1, characterized by further comprising one or more components selected from the croup of lubricants, dispersants, colorings, fillers, flavorings, appetizers, medications, vitamins, micro- and nano-spheres with controlled-release active ingredients.

7. Chew toy according to claim 1, wherein said components are delivered as such to the extruder or in the form of previously extruded or pelletized granules.

8. Chew toy according to claim 1, characterized by a homogeneous diffusion of cells.

9. Chew toy according to claim 1, characterized by an average surface roughness higher than 5 μm.

10. Process for manufacturing chew toys for domestic pets characterized by using an extruded sheet in a partially expanded or compact form according to claim 1, wherein the conversion of said sheet into the end product is obtained by mechanized means, or by hand.

11. Process for manufacturing chew toys for domestic pets according to claim 12, characterized in that said extruded sheet is cut into pieces of suitable length, said pieces then being rolled around their major axis and tied in knots at the two ends.

12. Process for manufacturing chew toys for domestic pets according to claim 13, wherein the extruded sheet undergoes a process of impregnation with water, water vapor or any other plasticizing fluid that makes it sufficiently plastic for subsequent handling.

13. Chew toy according to claim 2 characterized in that said biodegradable materials are of vegetable origin.

14. Chew toy according to claim 2, characterized by further comprising one or more components selected from the croup of lubricants, dispersants, colorings, fillers, flavorings, appetizers, medications, vitamins, micro- and nano-spheres with controlled-release active ingredients.

15. Chew toy according to claim 3, characterized by further comprising one or more components selected from the croup of lubricants, dispersants, colorings, fillers, flavorings, appetizers, medications, vitamins, micro- and nano-spheres with controlled-release active ingredients.

16. Chew toy according to claim 4, characterized by further comprising one or more components selected from the croup of lubricants, dispersants, colorings, fillers, flavorings, appetizers, medications, vitamins, micro- and nano-spheres with controlled-release active ingredients.

17. Chew toy according to claim 5, characterized by further comprising one or more components selected from the croup of lubricants, dispersants, colorings, fillers, flavorings, appetizers, medications, vitamins, micro- and nano-spheres with controlled-release active ingredients.

18. Chew toy according to claim 4, wherein said components are delivered as such to the extruder or in the form of previously extruded or palletized granules.

19. Chew toy according to claim 5, wherein said components are delivered as such to the extruder or in the form of previously extruded or palletized granules.

20. Chew toy according to claim 2, characterized by a homogeneous diffusion of cells.
